(19) United States
(12) Patent Application Publication
(10) Pub. No.: US 2024/0408970 A1
(43) Pub. Date: Dec. 12, 2024

(54) TRACTION NETWORK FOR A VEHICLE AND METHOD FOR OPERATING A TRACTION NETWORK

(71) Applicant: Volkswagen Aktiengesellschaft, Wolfsburg (DE)

(72) Inventor: Ruediger KUSCH, Braunschweig (DE)

(73) Assignee: Volkswagen Aktiengesellschaft, Wolfsburg (DE)

(21) Appl. No.: 18/737,213

(22) Filed: Jun. 7, 2024

(30) Foreign Application Priority Data
Jun. 7, 2023 (DE) 10 2023 205 302.0

(51) Int. Cl. B60L 15/00; B60L 53/12; B60L 53/16; B60L 53/22; H02M 3/158; H02M 7/539

(52) U.S. Cl. CPC B60L 15/007; B60L 53/12; B60L 53/16; B60L 53/22; H02M 3/158; H02M 7/539; B60L 2210/10

(57) ABSTRACT

A traction network for a vehicle, which comprises at least one high-voltage battery, an inverter, an electric machine, and a DC/DC converter. The DC/DC converter being arranged between the at least one high-voltage battery and the inverter. The inverter being arranged between the DC/DC converter and the electric machine. The DC/DC converter being configured in such a way that at least one phase for an inductive AC charger connection is connectable to center taps of half-bridges of the DC/DC converter. A DC/DC converter for a traction network and a method for operating a traction network are also provided.

This nonprovisional application claims priority under 35 U.S.C. § 119(a) to German Patent Application No. 10 2023 205 302.0, which was filed in Germany on Jun. 7, 2023, and which is herein incorporated by reference.

### BACKGROUND OF THE INVENTION

### Field of the Invention

The invention relates to a traction network for a vehicle and a method for operating a traction network.

### Description of the Background Art

The typical structure of a traction network is made up of a high-voltage battery, an inverter, and an electric machine. A DC/DC converter connected between the high-voltage battery and the inverter may be used to set a voltage level. In addition to a conductive DC charging and AC charging of the high-voltage battery, more and more approaches for inductive AC charging are entering the market.

### SUMMARY OF THE INVENTION

It is therefore an object of the invention to provide a traction network for a vehicle and a method for operating a traction network, in which an inductive AC charging may take place in an improved manner.

The object is achieved according to the invention by a traction network, a DC/DC converter, and a method. In particular, a traction network for a vehicle is provided, which comprises at least one high-voltage battery, an inverter, an electric machine, and a DC/DC converter, the DC/DC converter being arranged between the at least one high-voltage battery and the inverter, and the inverter being arranged between the DC/DC converter and the electric machine, the DC/DC converter being configured in such a way that at least one phase for an inductive AC charger connection is connectable to center taps of half-bridges of the DC/DC converter.

In particular, a method for operating a traction network is furthermore provided, a traction network including at least one high-voltage battery, an inverter, an electric machine, and a DC/DC converter, the DC/DC converter being arranged between the at least one high-voltage battery and the inverter, and the inverter being arranged between the DC/DC converter and the electric machine, the DC/DC converter being connected for inductive charging to at least one phase of an inductive AC charger connection in such a way that at the least one phase is connected to center taps of half-bridges of the DC/DC converter.

The traction network and the method make it possible to supply one or multiple inductive charge paths to the DC/DC converter and to also use components of the DC/DC converter to rectify an (inductive) AC charging current for charging the high-voltage battery. By using the components of the DC/DC converter for multiple functionalities, it is possible, in particular, to keep a necessary number of components in the traction network nearly constant as the functionality increases, so that complexity, installation space, and costs may be spared. For this purpose, it is provided that the DC/DC converter is configured in such a way that at least one phase for an inductive AC charger connection is connectable to center taps of half-bridges of the DC/DC converter. In particular, the DC/DC converter includes contacts configured for this purpose, for example, in the form of contact regions arranged on a module housing, which may be or are connected to the at least one phase of the inductive AC charger connection. As a result, the half-bridges of the DC/DC converter may be used for rectifying the inductively supplied AC charging current and are controlled for this purpose in a manner which is known per se. In a normal operating state, in which the DC/DC converter is used to set and/or adapt the voltage level, the center taps are connected to each other, in particular, via a storage inductor.

The DC/DC converter is used, in particular, to set and/or adapt a voltage level of the high-voltage battery for the inverter. This makes it possible to set and/or adapt the voltage level, in particular, independently of a state of charge of the high-voltage battery.

Power semiconductor switches (e.g., MOSFETs or IGBTs) of the DC/DC converter and the inverter are controlled in a manner known per se for the purpose of provided the functionality aimed for in each case. For this purpose, the traction network includes, in particular, one or multiple control devices, which generate and provide switching signals for the particular switching states of the power semiconductor switches.

The inductive AC charger connection may also be part of the traction network or be comprised thereof.

The DC/DC converter can include a switching logic, which is configured to establish a connection of the at least one phase for the inductive AC charger connection to the center taps of the half-bridges in one switching position. An electrical connection to the center taps may be established hereby in a targeted manner when an inductive AC charging is to take place. The switching state of the switching logic is set, in particular, with the aid of a control device of the traction network. It may be provided that the connection to the inductive AC charger connection is formed or becomes formed via contacts configured for this purpose.

The switching logic can have a further switching position, in which the at least one phase for the inductive AC charger connection is disconnected from the center taps, and the center taps of the half-bridges are connected to each other via a storage inductor. This makes it possible to switch back and forth between at least two switching positions in a targeted manner, depending on whether a setting and/or an adaptation of the voltage level or an inductive AC charging is/are to take place. The particular switching state of the switching logic is set, in particular, with the aid of a control device of the traction network.

The AC charger connection can have three phases, the DC/DC converter including three parallel branches with half-bridges, each of the three phases of the AC charger connection being assigned to one of the branches and being connectable to the particular center taps of the branches. A charging rate during the inductive AC charging may be increased hereby. In principle, further phases and/or branches of the DC/DC converter may also be provided.

The traction network can include a conductive AC charger connection. A conductive AC charging may also take place hereby.

The traction network can include a DC charger connection. A DC charging may also take place hereby.

The traction network can include a further switching logic, the further switching logic being arranged between the DC/DC converter and the inverter and being configured to establish a connection to the rectified conductive AC charger connection and/or the DC charger connection or to disconnect a connection of this type. The rectified conductive AC charger connection and/or the DC charger connection may be electrically connected or disconnected hereby to establish an electrical connection for charging or to disconnect it for another operating state. It may be provided that the further switching logic is configured to form an electrical connection between the DC/DC converter and the inverter in another switching state, an electrical connection to the rectified conductive AC charger connection and/or the DC charger connection being or becoming disconnected. It may furthermore be provided, in particular, that an electrical connection between the DC/DC converter and the inverter is disconnected or becomes disconnected when the DC/DC converter is connected or becomes connected to the rectified conductive AC charger connection and/or the DC charger connection. The particular switching state of the further switching logic is set, in particular, with the aid of a control device of the traction network.

The power semiconductor switches of half-bridges can be designed differently for different branches of the DC/DC converter. Different power classes for different branches may be provided hereby. For example, one branch, such as a branch via which a single-phase inductive AC charging is to take place, may have more powerful power semiconductor switches than two (or more) other branches. The power semiconductor switches of the other branches may then be provided more cost-effectively.

In particular a DC/DC converter may also be provided for a traction network, the DC/DC converter being configured in such a way that at least one phase for an inductive AC charger connection may be connected to center taps of half-bridges of the DC/DC converter. Further example of the DC/DC converter are derived from the description of example of the traction network. The advantages of the DC/DC converter in each case are the same as those in the example of the traction network. The DC/DC converter may be designed, for example, as a module, which includes additional contacts, which may be connected or are connected to the center taps of the half-bridges in the module, and at which a connection to the at least one phase of the inductive AC charger connection may be established from the outside. The DC/DC converter in the traction network is, in particular, controlled in a suitable manner, in particular with the aid of a control device configured for this purpose. The following operating modes, in particular, are possible: Setting and/or adapting a voltage level (bidirectionally) or rectifying the inductive AC charging current.

Further features for the method are derived from the description of the traction network. The advantages of the method in each case are the same as those in the examples of the traction network.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation for illustrating an example of the traction network for a vehicle;

FIG. 2 shows a schematic representation for illustrating an example of the traction network;

FIG. 3 shows a schematic representation for illustrating an example of the traction network;

FIG. 4 shows a schematic representation for illustrating an example of the traction network.

### DETAILED DESCRIPTION

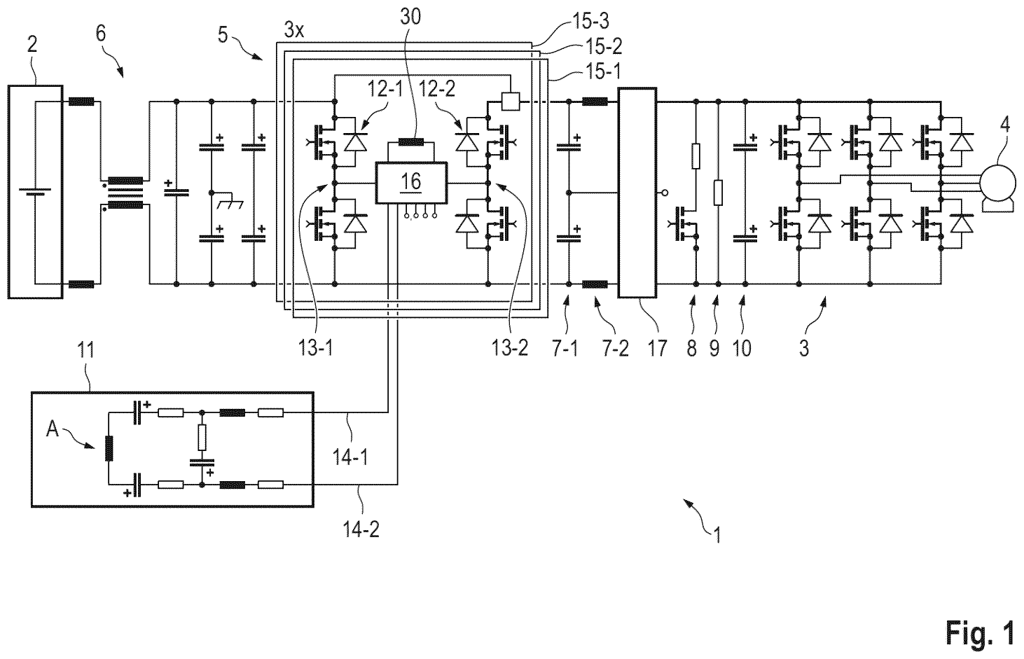

FIG. 1 shows a schematic representation for illustrating an example of traction network 1 for a vehicle. Traction network 1 comprises a high-voltage battery 2, an inverter 3, an electric machine 4, and a DC/D converter 5. DC/DC converter 5 is, in particular, a bidirectional DC/DC converter 5. DC/DC converter 5 is arranged between high-voltage battery 2 and inverter 3. Inverter 3 is arranged between DC/DC converter 5 and electric machine 4 and is designed, in particular, as a pulse inverter.

In particular, a two-stage DC input filter 6 is arranged between high-voltage battery 2 and DC/DC converter 5 and comprises multiple reactors and capacitors (which are not identified by their own reference numerals). In particular, DC-link capacitors 7-1 and reactance coils 7-2 as well as an active discharge branch 8, a passive discharge branch 9, and DC-link capacitors 10 are furthermore arranged between DC/DC converter 5 and inverter 3. Fuses 17 are also provided, with the aid of which a connection between DC/DC converter 5 and inverter 3 may be interrupted.

DC/DC converter 5 is configured in such a way that at least one phase A for an inductive AC charger connection 11 is connectable to center taps 13-1, 13-2 of half-bridges 12-1, 12-2 of DC/DC converter 5. For connection, lines 14-1, 14-2 of phase A are connected to center taps 13-1, 13-2, for example, line 14-1 to center tap 13-1, and line 14-2 to center tap 13-2. The connection always takes place when an inductive AC charging is to occur. If an inductive AC charging is to take place, the power semiconductor switches of half-bridges 12-1, 12-2 of DC/DC converter 5 are controlled accordingly to rectify the AC charging current and to charge high-voltage battery 2, in particular with the aid of a control device (not illustrated) of traction network 1 configured for this purpose.

DC/DC converter 5 comprises, in particular, three parallel-connected branches 15-x, which all have the same design in terms of structure and, in particular, each comprise two half-bridges 12-1, 12-2. An offset clocking of the power semiconductor switches of branches 15-x may take place hereby. In addition, the power semiconductor switches may also be provided with an asymmetrical design, i.e., the power semiconductor switches have different power classes. For example, it may be provided in the illustrated example that power semiconductor switches of branch 15-x of DC/DC converter 5 to be used for inductive AC charging are designed to be more powerful than the power semiconductor switches in the other branches 15-x. As a result, branch 15-x for inductive AC charging may be designed to be particularly powerful, while costs may be spared for the other branches 15-x if the power semiconductor switches there are designed to be less powerful.

It may be provided that DC/DC converter 5 includes a switching logic 16, which is configured to establish a connection of the at least one phase A for inductive AC charger connection 11 to center taps 13-1, 13-2 of half-bridges 12-1, 12-2 in one switching position. Switching logic 16 is, in particular, controlled by a control device (not illustrated) of traction network 1.

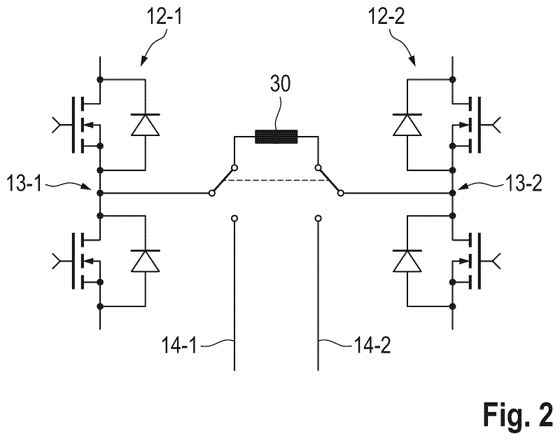

It may be provided that switching logic 16 has a further switching position, in which the at least one phase A for inductive AC charger connection 11 is disconnected from center taps 13-1, 13-2, and center taps 13-1, 13-2 of half-bridges 12-1, 12-2 are connected to each other via a storage inductor 30. This is illustrated schematically in FIG. 2, in which two switching positions are possible, center taps 13-1, 13-2 being connected either to storage inductor 30 (corresponding to the switching position shown in FIG. 2) or to lines 14-1, 14-2 of phase A.

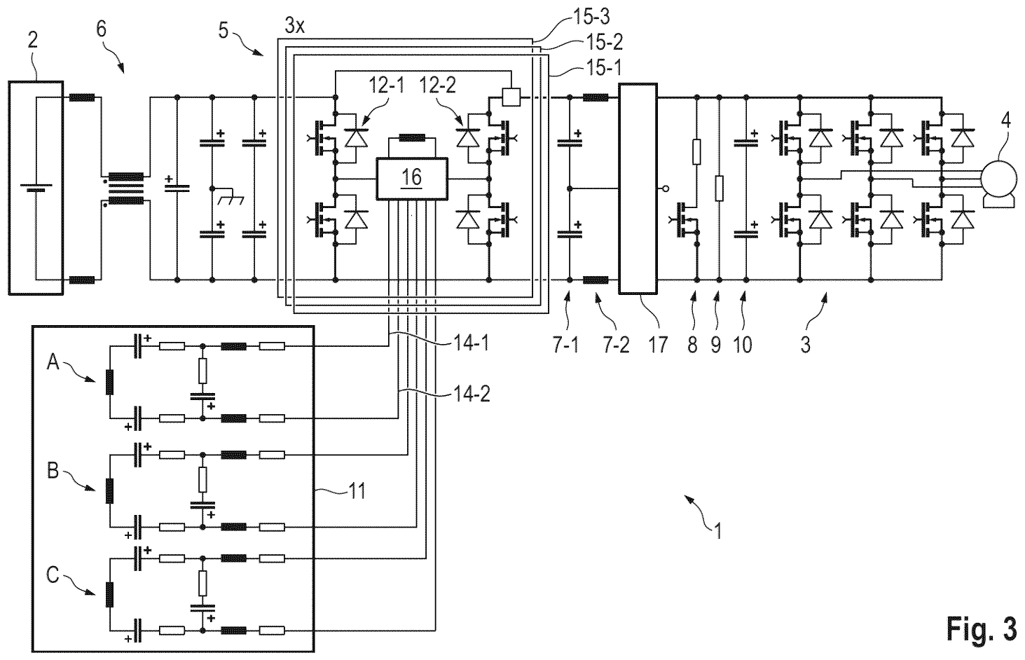

FIG. 3 shows a schematic representation for illustrating an example of traction network 1. In principle, the example has the same design as the examples described above, and the same reference numerals designate the same features and concepts. In the case of this example, it is provided that AC charger connection 11 has three phases A, B, C, DC/DC converter 5 including three parallel branches 15-x with half-bridges 12-1, 12-2, each of the three phases A, B, C of AC charger connection 11 being assigned to one of branches 15-x and being connectable to particular center taps 13-1, 13-2 of branches 15-x. In principle, the connection for each phase A, B, C takes place, in particular, as shown schematically in FIG. 2. If an inductive AC charging takes place across all three phases A, B, C, the power semiconductor switches of half-bridges 12-1, 12-2 of DC/DC converter 5 are controlled accordingly in all branches 15-x for the purpose of rectifying the AC charging current and charging high-voltage battery 2.

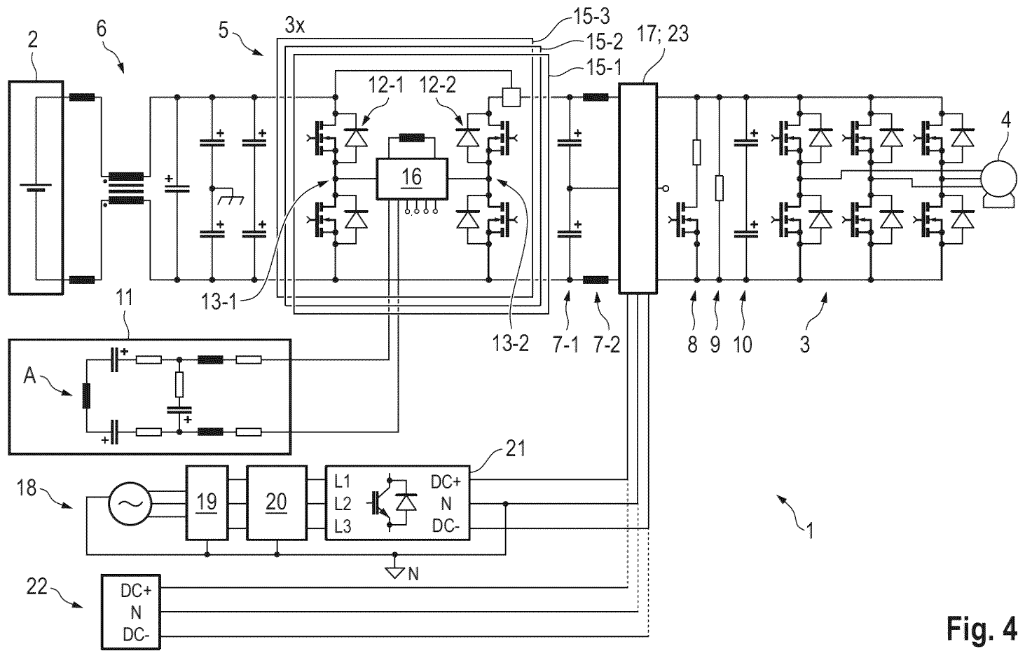

FIG. 4 shows a schematic representation for illustrating an example of traction network 1. The example generally has the same design as the examples described above, and the same reference numerals designate the same features and concepts. In the case of this example, it is provided that traction network 1 includes a conductive AC charger connection 18. Conductive AC charger connection 18 comprises, in particular, an input filter 19, a discharge current filter 20, and a rectifier 21, for example having power factor correction (PFC) as a neutral point clamped (NPC) or Vienna rectifier or a Weissach rectifier. Rectified conductive AC charger connection 18 is integrated into traction network 1 between DC/DC converter 5 and inverter 3.

It may be provided that traction network 1 includes a DC charger connection 22. This is illustrated schematically as an alternative to conductive AC charger connection 18. However, traction network 1 may also include a conductive AC charger connection 18 and a DC charger connection 22.

It may be provided that traction network 1 includes a further switching logic 23, further switching logic 23 being arranged between DC/DC converter 5 and inverter 3 and being configured to establish a connection to rectified conductive AC charger connection 18 and/or DC charger connection 22 or to disconnect a connection of this type. In the illustrated example, further switching logic 23 is formed together with fuses 17. Further switching logic 23 is configured, in particular, to connect DC/DC converter 5 to inverter 3 in one switching state, while connecting DC/DC converter 5 to DC charger connection 22 in another switching state and, in particular, to disconnect a connection to inverter 3. A third switching state may also be provided, in which DC/DC converter 5 becomes connected or is connected to conductive AC charger connection 18, and a connection to inverter 3 is disconnected.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A traction network for a vehicle, the traction network comprising:
at least one high-voltage battery;
an inverter;
an electric machine; and
a DC/DC converter arranged between the at least one high-voltage battery and the inverter, the inverter being arranged between the DC/DC converter and the electric machine, the DC/DC converter being configured such that at least one phase for an inductive AC charger connection is connectable to center taps of half-bridges of the DC/DC converter.

2. The traction network according to claim 1, wherein the DC/DC converter includes a switching logic, which is configured to establish a connection of the at least one phase for the inductive AC charger connection to the center taps of the half-bridges in one switching position.

3. The traction network according to claim 2, wherein the switching logic (has a further switching position, in which the at least one phase for the inductive AC charger connection is disconnected from the center taps, and wherein the center taps of the half-bridges are connected to each other via a storage inductor.

4. The traction network according to claim 1, wherein the AC charger connection has three phases, the DC/DC converter including three parallel branches with half-bridges, each of the three phases of the AC charger connection being assigned to one of the branches and being connectable to the particular center taps of the branches.

5. The traction network according to claim 1, further comprising a conductive AC charger connection.

6. The traction network according to claim 1, wherein further comprising a DC charger connection.

7. The traction network according to claim 5, further comprising an additional switching logic, the additional switching logic being arranged between the DC/DC converter and the inverter and being configured to establish a connection to the rectified conductive AC charger connection and/or a DC charger connection or to disconnect a connection of this type.

8. A DC/DC converter for a traction network, the DC/DC converter being configured such that at least one phase for an inductive AC charger connection is connectable to center taps of half-bridges of the DC/DC converter.

9. A method for operating a traction network, the method comprising:
providing the traction network with at least one high-voltage battery, an inverter, an electric machine, and a DC/DC converter;
arranging the DC/DC converter between the at least one high-voltage battery and the inverter;
arranging the inverter between the DC/DC converter and the electric machine; and
connecting the DC/DC converter to at least one phase of an inductive AC charger connection for inductive AC charging such that the at least one phase is connected to center taps of half-bridges of the DC/DC converter.

10. The method according to claim 9, characterized in that a switching logic (16) of the DC/DC converter (5) is controlled for the purpose of inductive AC charging in such a way that a contact of the at least one phase (A, B, C) for the inductive AC charger connection (11) is established with the center taps (13-x) of the half-bridges (12-x).
